(19) United States
(12) Patent Application Publication
(10) Pub. No.: US 2007/0035482 A1
(43) Pub. Date: Feb. 15, 2007

(54) Driving circuits and methods for driving display cells

(76) Inventors: Yu-Wen Chiou, Tainan County (TW); Chih-Heng Chu, Tainan County (TW); Ming-Cheng Chiu, Tainan County (TW); Lin-Kai BU, Tai-Nan County (TW)

Correspondence Address: NORTH AMERICA INTELLECTUAL PROPERTY CORPORATION, P.O. BOX 506, MERRIFIELD, VA, 22116, US

(21) Appl. No.: 11/161,644

(22) Filed: Aug. 11, 2005

(51) Int. Cl. G09G 3/30

(52) U.S. Cl. 345/76

(57) ABSTRACT

A driving circuit for driving a plurality of display cells, includes: a plurality of first switches, a plurality of driving units coupled to the first switches, and a plurality of second switches respectively corresponding to the first switches. The first switches receive and output a plurality of data signals, respectively. Each driving unit is utilized for driving at least one display cell of a row of display cells according to a data signal. The driving circuit outputs a driving signal corresponding to a specific data signal received and outputted by a specific first switch.

### BACKGROUND OF THE INVENTION

1. Field of the Invention

The present invention relates to driving circuits and methods for driving display cells, and more particularly, to driving circuits and methods for driving passive matrix organic light emitting diodes (PMOLEDs).

2. Description of the Prior Art

Organic light emitting diodes (OLEDs) can be classified to be active matrix OLEDs (AMOLEDs) or passive matrix OLEDs (PMOLEDs) according to driving architectures thereof, where the PMOLEDs have been widely applied to electronic products.

Please refer to FIG. 1. FIG. 1 is a diagram of a driving circuit for driving a plurality of OLEDs according to the prior art, where the driving circuit comprises a plurality of driving units 10-1, 10-2, . . . , and 10-N respectively coupled to an static random access memory (SRAM) 8. Each driving unit 10-K (K=1, 2, . . . , N) comprises a line buffer 12-K, two latches 21-K and 22-K, a comparator 30-K, and a current mirror circuit 40-K. As shown in FIG. 1, the driving units 10-1, 10-2, . . . , and 10-N respectively output driving signals D2-1, D2-2, . . . , and D2-N according to data signals D1-1, D1-2, . . . , and D1-N to drive the OLEDs. The OLEDs are typically driven utilizing pulse width modulation (PWM) according to data carried by the data signals D1-1, D1-2, . . . , and D1-N, where gray levels displayed by the OLEDs depend on corresponding pulse widths.

In an ideal case, current values of the driving signals D2-1, D2-2, . . . , and D2-N should be uniform, i.e., the current values are equal to one another, in order to achieve perfect uniformity while all the OLED are driven to display the same gray level. However, in a real case, the current values of the driving signals D2-1, D2-2, . . . , and D2-N are not uniform due to a certain reason such as inconsistent characteristics of a transistor P2-K of a current mirror 42-K (as shown in FIG. 2) in the current mirror circuit 40-K.

### SUMMARY OF THE INVENTION

It is an objective of the claimed invention to provide methods and circuits for driving display cells.

According to one embodiment of the claimed invention, a driving circuit for driving a plurality of display cells is disclosed. The driving circuit comprises: a plurality of first switches receiving and outputting a plurality of data signals, respectively; a plurality of driving units coupled to the first switches, each driving unit for driving at least one display cell of a row of display cells according to a data signal; and a plurality of second switches coupled to the driving units, the second switches respectively corresponding to the first switches, each second switch outputting a driving signal received from a driving unit; wherein a specific second switch outputs a driving signal corresponding to a specific data signal received and outputted by a specific first switch corresponding to the specific second switch.

According to one embodiment of the claimed invention, a driving circuit for driving a plurality of display cells is disclosed. The driving circuit comprises: a plurality of first switches receiving and outputting a plurality of data signals, respectively; a plurality of driving units coupled to the first switches, each driving unit for driving at least one display cell of a row of display cells according to a data signal; and a plurality of second switches respectively corresponding to the first switches, at least a portion of the second switches being embedded in at least a portion of the driving units, the portion of the second switches being capable of switching wiring of transistors of the portion of the driving units; wherein a specific driving unit outputs a driving signal corresponding to a specific data signal received and outputted by a specific first switch corresponding to the specific driving unit.

According to one embodiment of the claimed invention, a driving method for driving a plurality of display cells is disclosed. The driving method comprises: providing a plurality of first switches; providing a plurality of driving units coupled to the first switches; providing a plurality of second switches respectively corresponding to the first switches; coupling the second switches to the driving units or embedding at least a portion of the second switches in at least a portion of the driving unit; utilizing the first switches to receive, rearrange, and output the data signals; utilizing the driving unit to drive at least one display cell of a row of display cells according to a data signal; and outputting a driving signal corresponding to a specific data signal received and outputted by a specific first switch.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a driving circuit according to the prior art.

FIG. 2 is a diagram of a current mirror implemented in a driving circuit according to the prior art.

FIG. 3 is a diagram of a driving circuit according to one embodiment of the present invention.

FIG. 4 is a diagram of a driving circuit according to one embodiment of the present invention.

FIG. 5 is a diagram of a mirror-switch circuit according to one embodiment of the present invention.

### DETAILED DESCRIPTION

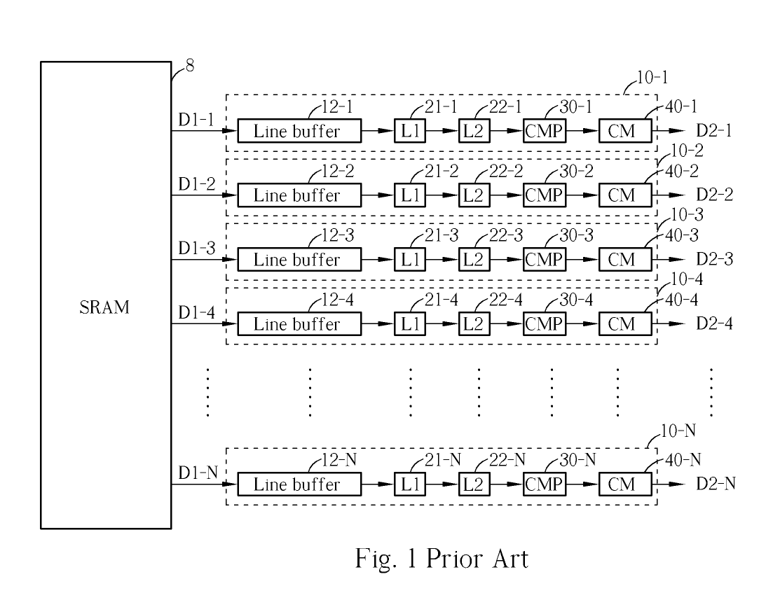

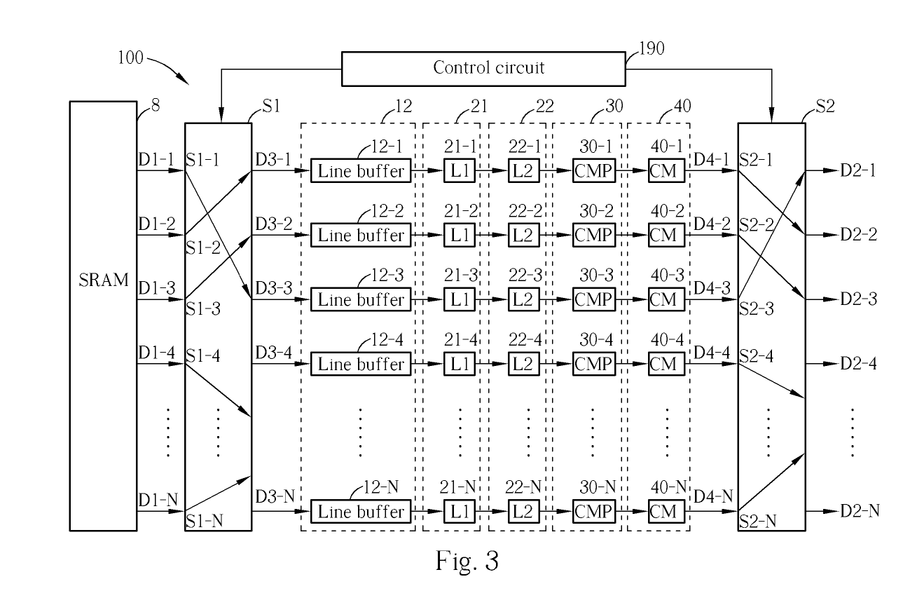

Please refer to FIG. 3. FIG. 3 is a diagram of a driving circuit for driving a plurality of display cells such as organic light emitting diodes (OLEDs) according to one embodiment of the present invention, where the driving circuit comprises: a first switching circuit S1 comprising a plurality of first switches S1-1, S1-2, . . . , and S1-N, the aforementioned driving units 10-1, 10-2, . . . , and 10-N shown in FIG. 1, a second switching circuit S2 comprising a plurality of second switches S2-1, S2-2, . . . , and S2-N, and a control circuit 190, where each driving unit 10-K (K=1, 2, . . . , N) comprises the line buffer 12-K, the two latches 21-K and 22-K, the comparator 30-K, and the current mirror circuit 40-K, and these components of the driving units 10-1, 10-2, . . . , and 10-N are classified into a plurality of stages comprising a line buffer stage 12, two latch stages 21 and 22, a comparator stage 30, and a current mirror stage 40.

According to the present invention, each driving unit, for example, the driving unit 10-K, is typically utilized for driving at least one display cell of a row of display cells according to a data signal, and more particularly in this embodiment, for driving the row of display cells according to the data signal. Each line buffer, for example, the line buffer 12-K of the driving unit 10-K, is utilized for temporarily storing data carried by the data signal received by the driving unit 10-K. Additionally, each latch, for example, the latch 21-K or the latch 22-K of the driving unit 10-K, is utilized for latching the data carried by the data signal received by the driving unit 10-K. In addition, each second switch, for example, the second switch S2-K, outputs a driving signal D4-K received from the corresponding driving unit 10-K.

The control circuit 190 controls the first switches S1-1, S1-2, . . . , and S1-N to periodically rearrange the data signals D1-1, D1-2, . . . , and D1-N to be respectively received by the driving units, and controls the second switches S2-1, S2-2, . . . , and S2-N accordingly such that a specific second switch S2-K′ (which is periodically varied within at least a portion of the second switches) outputs the driving signal D2-K corresponding to the specific data signal D1-K received and outputted by a specific first switch S1-K corresponding to the specific second switch S2-K′. For example, in a specific time interval within a period, the second switch S2-3 outputs the driving signal D2-1 corresponding to the data signal D1-1 received and outputted by the first switch S1-1 corresponding to the second switch S2-3. The first switch S1-1 alters the path of the data signal D1-1 and outputs the data signal D1-1 as the data signal D3-3. The data signal D3-3 is inputted into the corresponding driving unit (i.e., 10-3) that outputs the driving signal D4-3 to be received by the second switch S2-3. The second switch S2-3 alters the path accordingly and outputs the driving signal D4-3 as the driving signal D2-1.

In variations of the embodiment shown in FIG. 3, the first switching circuit S1 and the stages 12, 21, 22, and 30 can be rearranged. That is, the first switching circuit S1 can be inserted between two of the stages 12, 21, 22, 30, and 40 mentioned above.

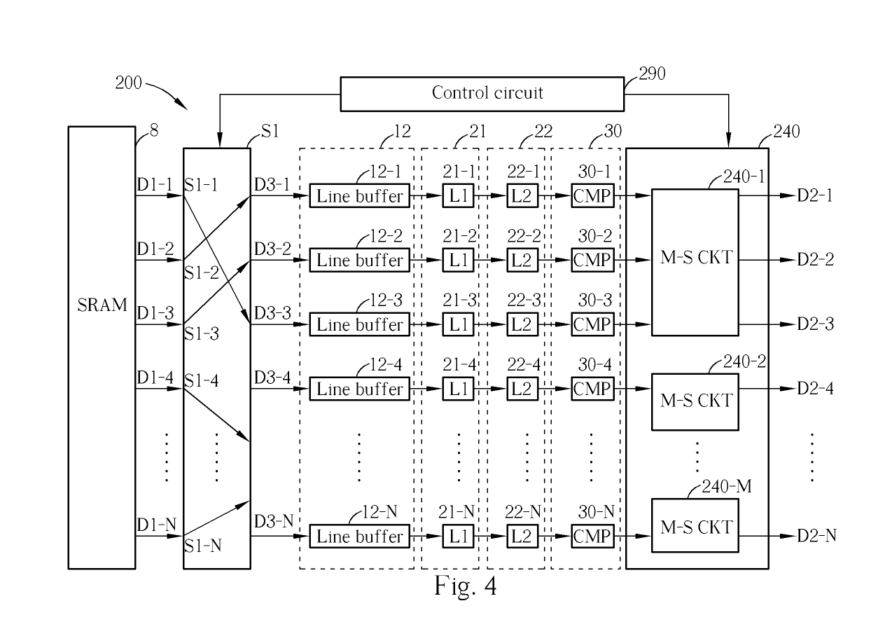

FIG. 4 is a diagram of a driving circuit according to one embodiment of the present invention, where at least one portion of the second switching circuit S2 (i.e., the second switches) mentioned above is embedded in at least one portion of the current mirror stage 40 (i.e., the current mirror circuits). According to this embodiment, each mirror-switch (M-S) circuit 240-L (L=1, 2, . . . , M) comprises J current mirror circuits 40-(J*(L−1)+1), 40-(J*(L−1)+2), . . . , and 40-(J*L), and J second switches S2-(J*(L−1)+1), S2-(J*(L−1)+2), . . . , and S2-(J*L) embedded therein, where J=3 in this embodiment.

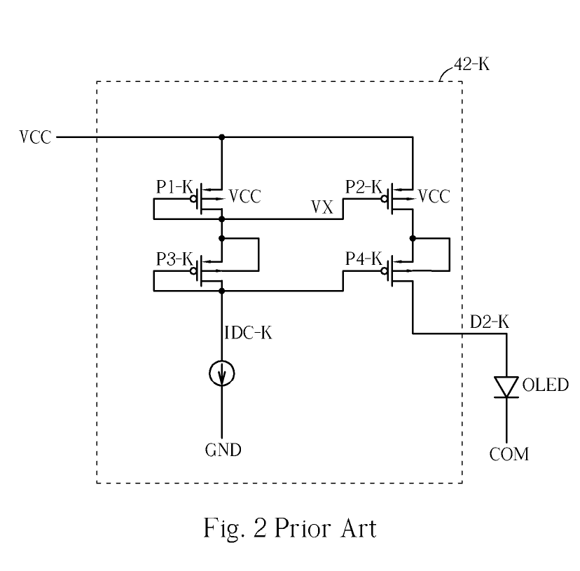

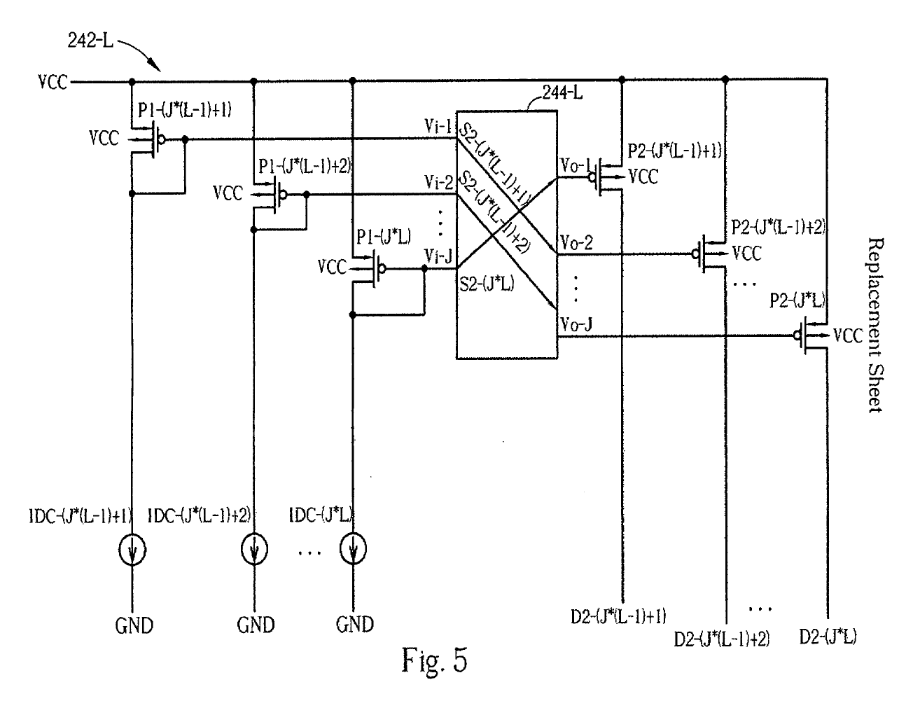

FIG. 5 is a diagram of an M-S circuit according to one embodiment of the present invention, where the architecture shown in FIG. 5 can be applied to the embodiment shown in FIG. 4. As shown in FIG. 5, a portion 242-L of each M-S circuit 240-L (L=1, 2, . . . , M) comprises J current mirrors, which are J copies of the current mirror 42-K shown in FIG. 2 with K varied from (J*(L−1)+1) to (J*L), and a switching module 244-L comprising J second switches S2-(J*(L−1)+1), S2-(J*(L−1)+2), . . . , and S2-(J*L) embedded therein. It is noted that the switching module 244-L of this embodiment operates according to the control of the control circuit 290, in order to switch wiring of transistors within the portion 242-L, and more particularly, alter the paths corresponding to the voltage VX shown in FIG. 2. As a result, a specific driving unit outputs the driving signal D2-K corresponding to the specific data signal D1-K received and outputted by a specific first switch S1-K corresponding to the specific driving unit.

Those skilled in the art will readily observe that numerous modifications and alterations of the device and method may be made while retaining the teachings of the invention. Accordingly, the above disclosure should be construed as limited only by the metes and bounds of the appended claims.

1. A driving circuit for driving a plurality of display cells, comprising:
a plurality of first switches receiving and outputting a plurality of data signals, respectively;
a plurality of driving units coupled to the first switches, each driving unit for driving at least one display cell of a row of display cells according to a data signal; and
a plurality of second switches coupled to the driving units, the second switches respectively corresponding to the first switches, each second switch outputting a driving signal received from a driving unit;
wherein a specific second switch outputs a driving signal corresponding to a specific data signal received and outputted by a specific first switch corresponding to the specific second switch.

2. The driving circuit of claim 1, wherein the display cells are organic light emitting diodes (OLEDs).

3. The driving circuit of claim 1, wherein each driving unit comprises a current mirror for driving the at least one display cell of the row of display cells.

4. The driving circuit of claim 3, wherein the current mirror drives the row of display cells.

5. The driving circuit of claim 3, wherein each driving unit further comprises at least one latch for latching data carried by the data signal received by the driving unit, and the first switches are respectively coupled to latches of the driving units.

6. The driving circuit of claim 3, wherein each driving unit further comprises a line butter for temporarily storing data carried by the data signal received by the driving unit, and the first switches are respectively coupled to line buffers of the driving units.

7. The driving circuit of claim 1, further comprising a control circuit for controlling the first and second switches, wherein the control circuit controls the first switches to rearrange the data signals to be respectively received by the driving units, and controls the second switches accordingly such that the specific second switch outputs the driving signal corresponding to the specific data signal received and outputted by the specific first switch corresponding to the specific second switch.

8. The driving circuit of claim 7, wherein the control circuit controls the first switches to periodically rearrange the data signals to be respectively received by the driving units.

9. A driving circuit for driving a plurality of display cells, comprising:
a plurality of first switches receiving and outputting a plurality of data signals, respectively;
a plurality of driving units coupled to the first switches, each driving unit comprising a current mirror for driving at least one display cell of a row of display cells according to a data signal; and
a plurality of second switches respectively corresponding to the first switches, at least a portion of the second switches being embedded in current mirrors or at least a portion of the driving units, the portion of the second switches being capable of switching wiring of transistors of the current mirrors of the portion of the driving units, so as to replace a current path of one current mirror with a corresponding current path of another current mirror;
wherein a specific driving unit outputs a driving signal corresponding to a specific data signal received and outputted by a specific first switch corresponding to the specific driving unit.

10. The driving circuit of claim 9, wherein the display cells are organic light emitting diodes (OLEDs).

11. (canceled)

12. The driving circuit of claim 9, wherein the current mirror drives the row of display cells.

13. (canceled)

14. The driving circuit of claim 9, wherein each driving unit further comprises at least one latch for latching data carried by the data signal received by the driving unit, and the first switches are respectively coupled to latches of the driving units.

15. The driving circuit of claim 9, wherein each driving unit further comprises a line buffer for temporarily storing data carried by the data signal received by the driving unit, and the first switches are respectively coupled to line buffers of the driving units.

16. The driving circuit of claim 9, further comprising:
a control circuit for controlling the first and second switches, wherein the control circuit controls the first switches to rearrange the data signals to be respectively received by the driving units, and controls the second switches accordingly such that the specific driving unit outputs the driving signal corresponding to the specific data signal received and outputted by the specific first switch corresponding to the specific driving unit.

17. The driving circuit of claim 16, wherein the control circuit controls the first switches to periodically rearrange the data signals to be respectively received by the driving units.

18. A driving method for driving a plurality of display cells, comprising:
providing a plurality or first switches;
providing a plurality of driving units coupled to the first switches, each driving unit comprising a current mirror;
providing a plurality of second switches respectively corresponding to the first switches;
embedding at least a portion of the second switches in current mirrors of at least a portion of the driving unit;
utilizing the first switches to receive, rearrange, and output the data signals;
utilizing the current mirror of the driving unit to drive at least one display cell of a row of display cells according to a data signal;
utilizing the portion of the second switches to switch wiring of transistors of the current mirrors of the portion of the driving units, so as to replace a current path of one current mirror with a corresponding current path of another current mirror; and
utilizing a specific driving unit to output a driving signal corresponding to a specific data signal received and outputted by a specific first switch corresponding to the specific driving unit.

19. (canceled)

20. The driving method of claim 18, wherein the step of utilizing the first switches to receive, rearrange, and output the data signals further comprises:
utilizing the first switches to periodically rearrange the data signals to be respectively received by the driving units.
